(19) United States
(12) Patent Application Publication
(10) Pub. No.: US 2025/0377073 A1
(43) Pub. Date: Dec. 11, 2025

(54) STRUT MOUNTING BRACKET ASSEMBLIES

(71) Applicant: WCM Industries, Inc., Colorado Springs, CO (US)

(72) Inventors: Eric PILARCZYK, Colorado Springs, CO (US); William T. BALL, Colorado Springs, CO (US)

(73) Assignee: WCM Industries, Inc., Colorado Springs, CO (US)

(21) Appl. No.: 19/038,942

(22) Filed: Jan. 28, 2025

Related U.S. Application Data
(60) Provisional application No. 63/658,724, filed on Jun. 11, 2024.

(51) Int. Cl. F16M 13/02

(52) U.S. Cl. CPC F16M 13/02

(57) ABSTRACT

An improved strut mounting bracket and its components are disclosed. The strut mounting bracket includes a securing portion and an extending portion. The securing portion may be configured to couple to a surface. The extending portion is coupled to the securing portion and extends substantially perpendicularly from the securing portion. The extending portion is configured to slidingly receive a strut over the extending portion. The extending portion includes a plurality of protrusions configured to frictionally contact inside surfaces of the strut. The plurality of protrusions cause the strut to resist movement towards the securing portion, locking the strut in place when strut mounting brackets are used on both ends of the strut. The extending portion may include one or more openings configured to receive screws or any other clamping mechanism to further lock the strut mounting bracket to the strut.

### CROSS-REFERENCE TO RELATED APPLICATIONS

This application claims the benefit of U.S. Provisional No. 63/658,724, filed Jun. 11, 2024, entitled “Strut Mounting Bracket Assemblies,” which is incorporated herein by reference in its entirety.

### INTRODUCTION

Struts may comprise elongated members that are used to support, hold, or brace various structures or components. Strut mounting brackets may be used to secure struts to wall components, such as studs. In addition, various components, such as electrical boxes, valves, electronics, etc., may be secured to struts in order to hold them in place.

It is with respect to this general technical environment that aspects of the present technology disclosed herein have been contemplated. Furthermore, although a general environment is discussed, it should be understood that the examples described herein should not be limited to the general environment identified herein.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an aspect, the present application relates to a strut mounting bracket, comprising: a securing portion configured to couple to a surface; and an extending portion coupled to the securing portion, wherein the extending portion has a substantially U-shaped cross section, wherein the extending portion is configured to slidingly receive a strut, wherein the extending portion comprises a plurality of protrusions, and wherein the plurality of protrusions are configured to frictionally contact an inside surface of the strut.

In some examples, the plurality of protrusions are configured to deflect inwards when the extending portion slidingly receives the strut and resist longitudinal movement of the strut.

In some examples, the extending portion includes a tapered end.

In some examples, a longitudinal axis of the extending portion is substantially perpendicular to a planar surface of the securing portion.

In some examples, at least one of the plurality of protrusions is configured to exert a normal force on an end of the strut.

In some examples, the extending portion comprises a base portion, a first raised side portion, and a second raised side portion, wherein the base portion is coupled to the first raised side portion and the second raised side portion.

In some examples, the first raised side portion and the second raised side portion are at substantially obtuse angles relative to the base portion.

In some examples, the base portion comprises a plurality of openings that are substantially circular.

In some examples, the base portion is wider than first raised side portion or the second raised side portion.

In some examples, the indented track comprises a first flat surface and a second flat surface, and wherein the first flat surface is substantially perpendicular to the second flat surface.

In some examples, the plurality of protrusions comprise a plurality of ridges.

In some examples, each protrusion of the plurality of protrusions has a first side and a second side that is angled relative to the first side.

In some examples, the securing portion comprises a plurality of openings.

In some examples, the plurality of protrusions cause the strut to resist movement in a first linear direction toward the securing portion more than in a second, opposite linear direction away from the securing portion.

In some examples, the securing portion and the extending portion comprise a single integral part.

In another aspect, the present application relates to a mounting bracket, comprising: a securing portion configured to couple to a surface; and an extending portion coupled to the securing portion, wherein the extending portion is configured to slidingly receive a strut, and wherein the extending portion comprises: a base portion; a first raised side portion coupled to the base portion; and a second raised side portion coupled to the base portion, wherein the first raised side portion comprises a first plurality of protrusions configured to contact a first inside surface of the strut, wherein the second raised side portion comprises a second plurality of protrusions configured to contact a second inside surface of the strut, and wherein a first distance between a first protrusion of the first plurality of protrusions and a second protrusion of the second plurality of protrusions is greater than a second distance between the first inside surface and the second inside surface.

In some examples, the first plurality of protrusions and the second plurality of protrusions are configured to deflect inwards when the extending portion slidingly receives the strut.

In some examples, the extending portion includes a tapered end.

In some examples, the extending portion is substantially perpendicular to the securing portion.

In another aspect, the present application relates to a strut mounting bracket assembly, comprising: a strut; a first strut mounting bracket, comprising: a first securing portion configured to couple to a first surface, and a first extending portion coupled to the first securing portion, wherein the first extending portion is configured to slidingly receive a first end of the strut, wherein the first extending portion comprises a first plurality of protrusions configured to contact a first inside surface of the strut and resist movement of the strut in a first longitudinal direction more than movement in a second, opposite longitudinal direction; and a second strut mounting bracket, comprising: a second securing portion configured to couple to a second surface, and a second extending portion coupled to the second securing portion, wherein the second extending portion is configured to slidingly receive a second end of the strut, wherein the second extending portion comprises a second plurality of protrusions configured to contact a second inside surface of the strut and resist movement of the strut in the second longitudinal direction more than movement in the first longitudinal direction.

It is to be understood that both the foregoing general description and the following Detailed Description are explanatory and are intended to provide further aspects and examples of the disclosure as claimed.

### BRIEF DESCRIPTION OF THE DRAWINGS

The following drawing figures, which form a part of this application, are illustrative of aspects of systems and methods described below and are not meant to limit the scope of the disclosure in any manner, which scope shall be based on the claims.

FIGS. 1-3 illustrate a strut mounting bracket assembly in isometric views.

FIGS. 4 and 5 illustrate a strut mounting bracket assembly in top views.

FIG. 6 illustrates a strut mounting bracket assembly in a side view.

FIGS. 7 and 8 illustrate a strut mounting bracket in isometric views.

FIG. 9 illustrates a strut mounting bracket in a front view.

FIG. 10 illustrates a strut mounting bracket in a top view.

FIG. 11 illustrates a strut mounting bracket in a side view.

While examples of the disclosure are amenable to various modifications and alternative forms, specific aspects have been shown by way of example in the drawings and are described in detail below. The intention is not to limit the scope of the disclosure to the particular aspects described. On the contrary, the disclosure is intended to cover all modifications, equivalents, and alternatives falling within the scope of the disclosure and the appended claims.

### DETAILED DESCRIPTION

As discussed briefly above, struts are elongated members that are used to support, hold, or brace various structures or components, such as electrical components (electrical boxes, control circuitry, switches, etc.), plumbing components (e.g., valves, valve controls, piping, etc.), machinery, or the like. Strut mounting brackets are used to secure struts to walls or other surfaces. For example, strut mounting brackets may be coupled to opposing surfaces of adjacent wall frame members (e.g., studs). In examples, two strut mounting brackets may hold a strut in a horizontal position between wall studs. In other examples, strut mounting brackets may be used to hold a strut in a vertical position or an angled position between two studs or other mounting surfaces. In examples, a component (e.g., a control valve) may be coupled to the strut to hold the component in a particular location in the wall. However, distances between opposite members of the wall frame may be different in different circumstances. Further, struts may be of varying lengths, or may be of a standard length with no other length options readily available. In examples, presently disclosed strut mounting brackets can accommodate varying strut lengths and varying distances between opposite surfaces. For example, implementation of the presently disclosed strut mounting brackets provides a range between a minimum and maximum length that is able to be supported by the strut and strut mounting brackets, as will be discussed. In addition, presently disclosed strut mounting brackets may ease installation of a strut, as will be discussed.

In accordance with examples described herein, an improved strut mounting bracket is described. The strut mounting bracket includes a securing portion and an extending portion. The securing portion may be configured to couple to a surface (e.g., a surface of a member of a wall frame). The extending portion is coupled to the securing portion and extends substantially away (e.g., substantially perpendicularly) from the securing portion. The extending portion is configured to slidingly receive a strut. At least one surface of the extending portion includes a plurality of protrusions (e.g., ridges, bumps, or the like) configured to frictionally contact inside surfaces of the strut and resist unwanted movement of the strut relative to the strut mounting bracket. In examples, the protrusions are shaped and sized to cause movement of a strut relative to the strut mounting bracket to be resisted in one linear direction more than in an opposite linear direction. In examples, movement of the strut towards the securing portion is more significantly resisted, while movement of the strut away from the securing portion is less restricted. For example, movement of the strut towards the securing portion of a strut mounting bracket may require a higher degree of force and/or may require that protrusions between an end of the strut and the securing portion be pinched in to allow the strut to move more easily towards the securing portion. In examples, this arrangement may effectively lock the strut in place when strut mounting brackets are used on both ends of the strut because the movement of the strut is resisted in either linear direction by the projections on one strut mounting bracket or the other. Such a design allows the strut mounting bracket to accommodate varying strut lengths and varying distances between opposite connecting surfaces, while allowing for simple installation and adjustment.

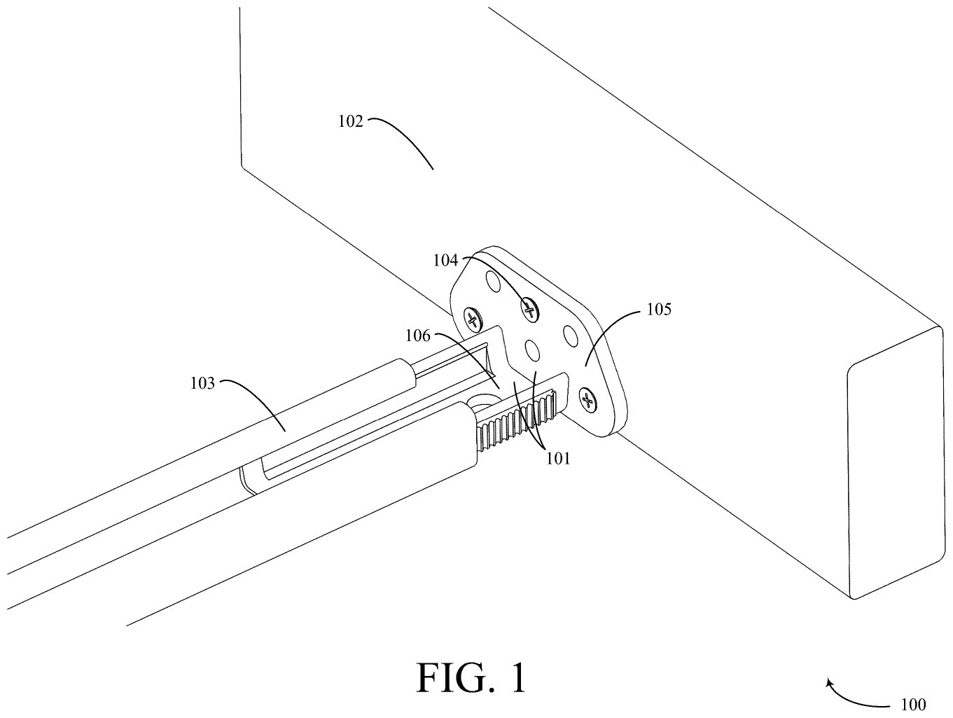

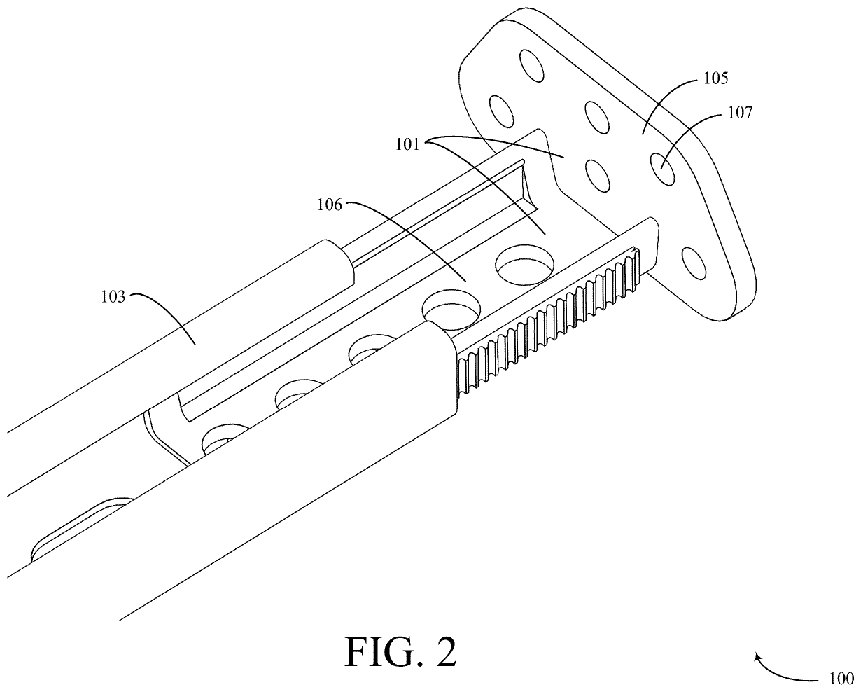

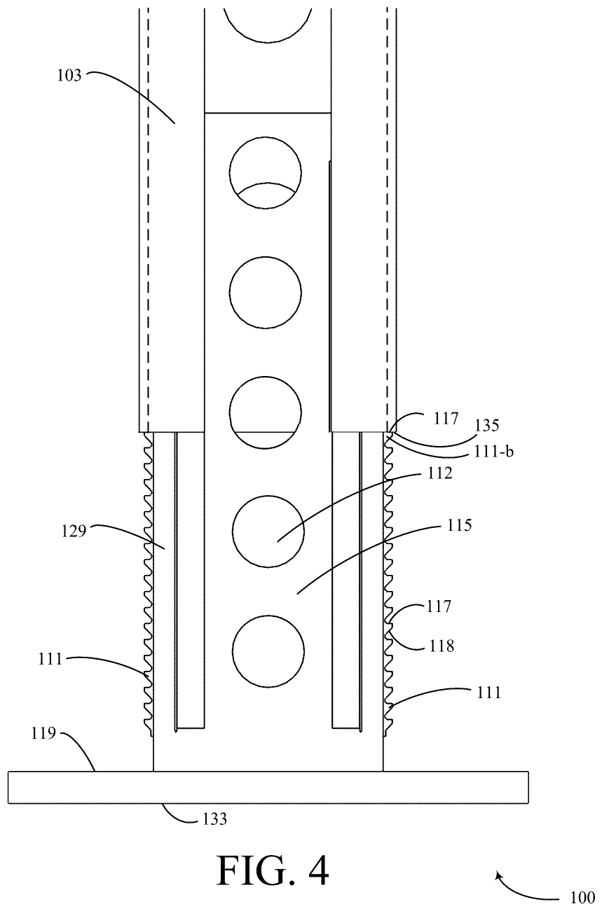

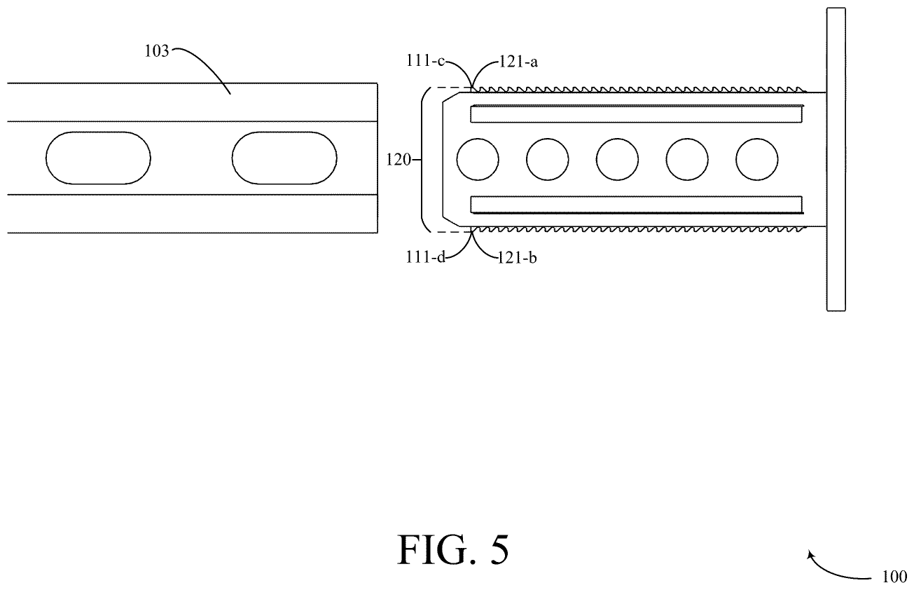

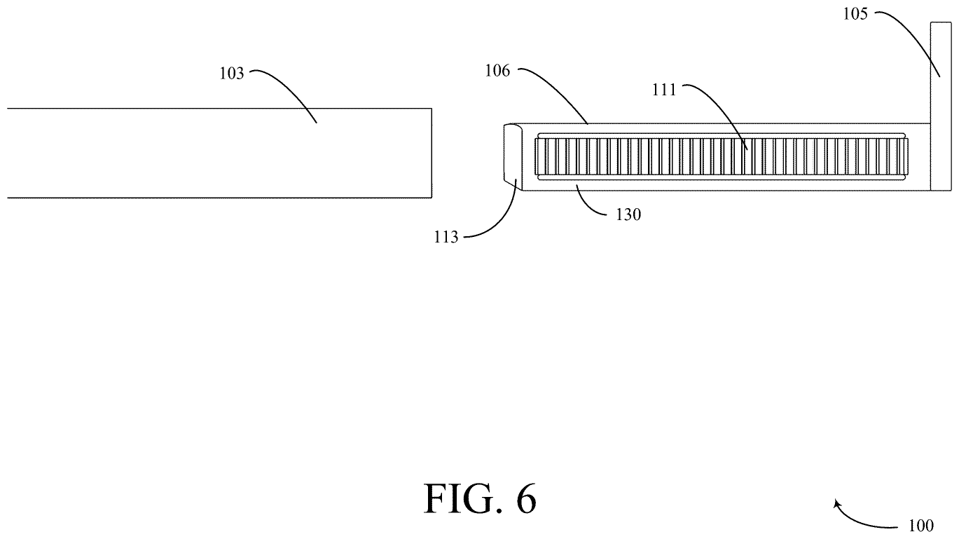

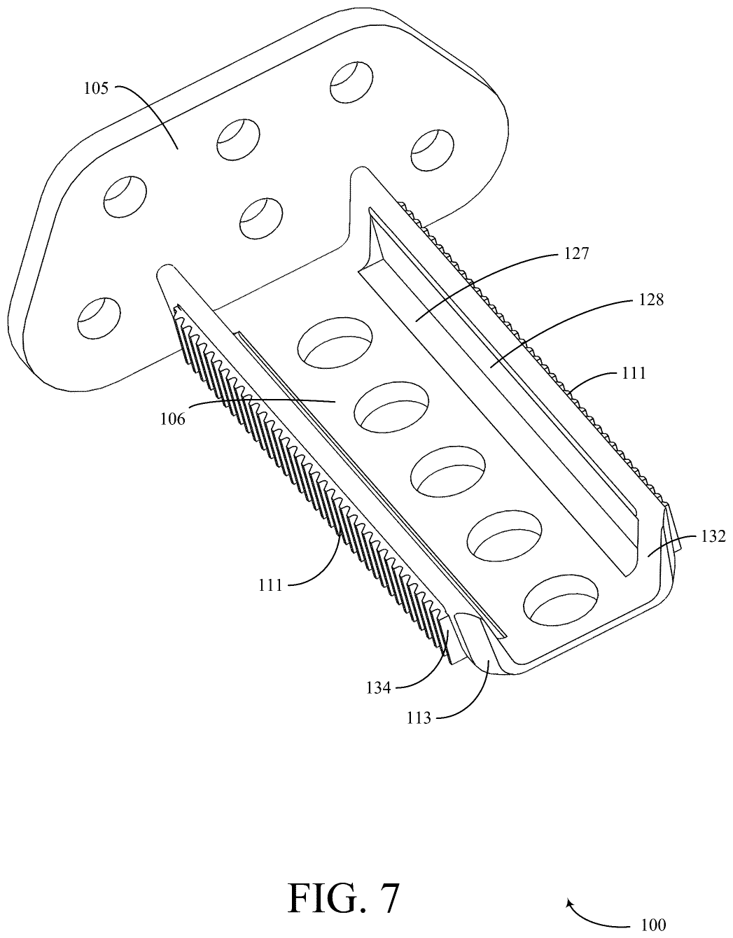

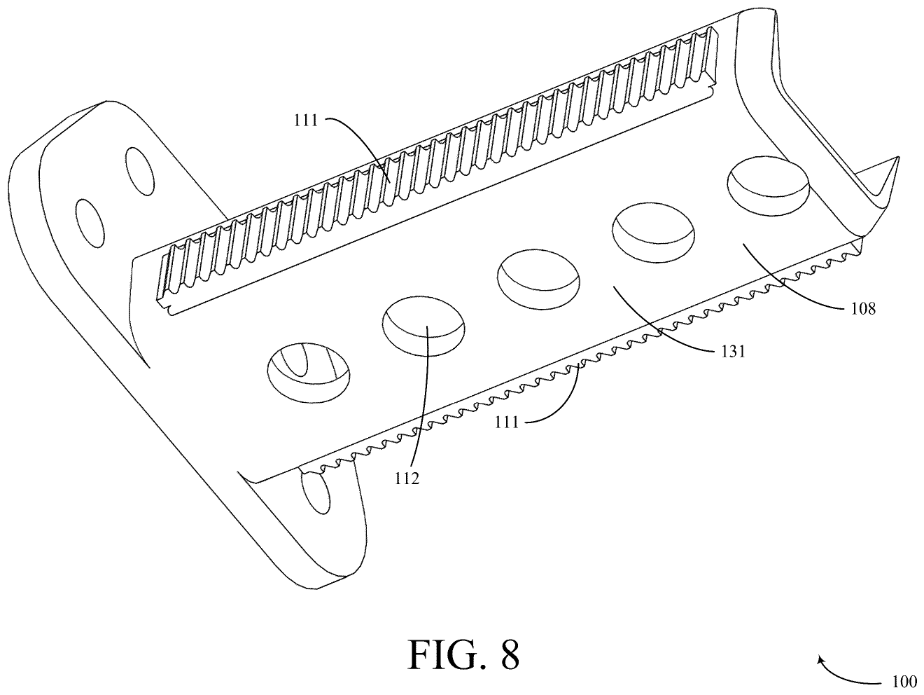

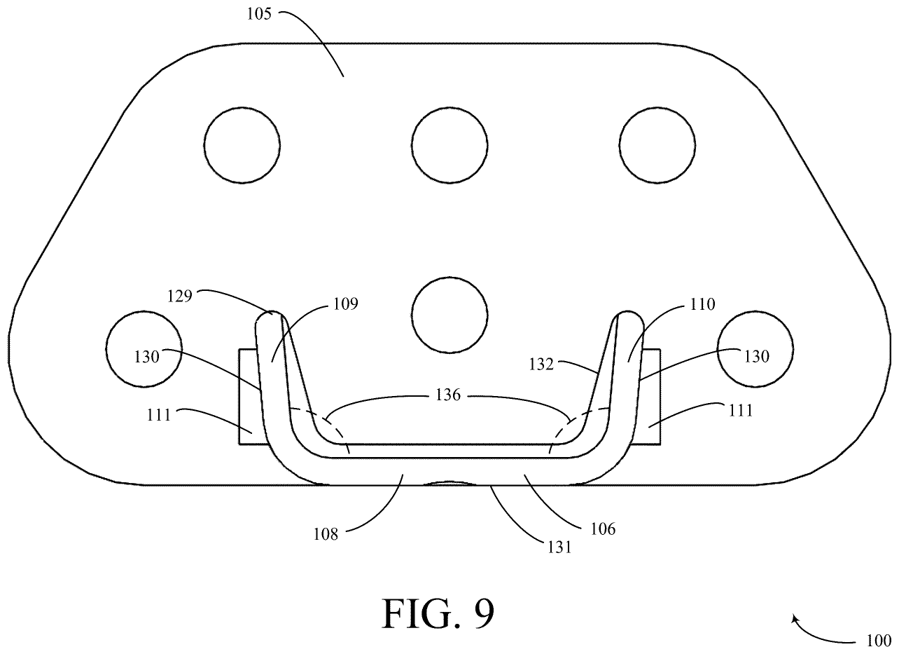

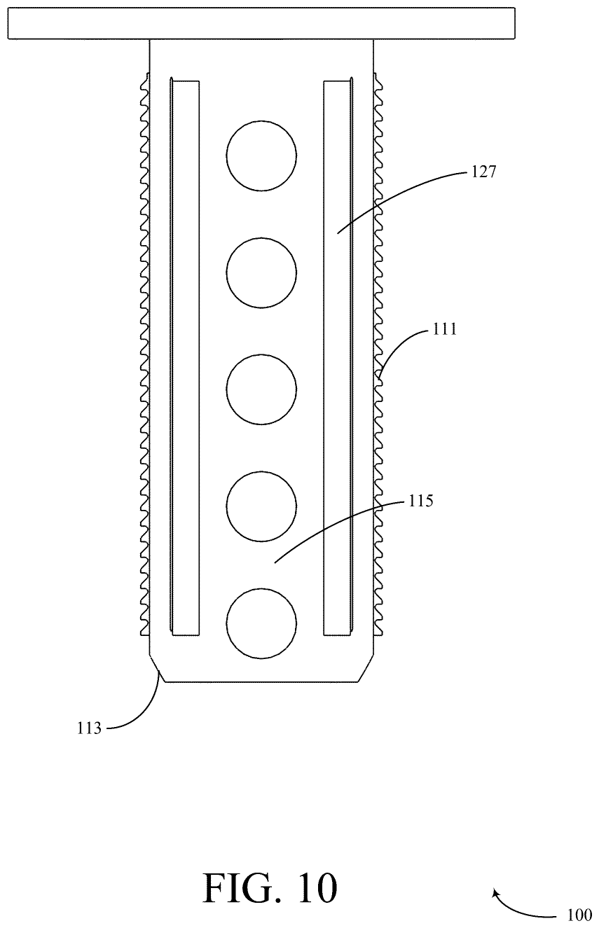

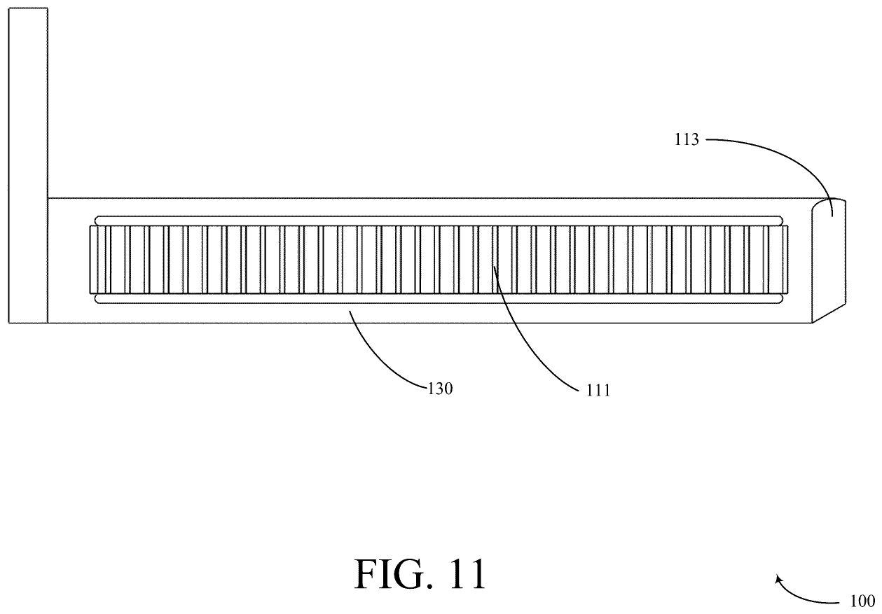

FIGS. 1-3 illustrate strut mounting bracket assembly 100 in isometric views. FIGS. 4 and 5 illustrate strut mounting bracket assembly 100 in top views. FIG. 6 illustrates strut mounting bracket assembly 100 in a side view. FIGS. 7 and 8 illustrate strut mounting bracket 101 in isometric views. FIG. 9 illustrates strut mounting bracket 101 in a front view. FIG. 10 illustrates strut mounting bracket 101 in a top view. FIG. 11 illustrates strut mounting bracket 101 in a side view. Repeated discussion of similar features is omitted for brevity.

Referring concurrently to FIGS. 1-11, strut mounting bracket assembly 100 includes strut mounting bracket 101, surface 102, strut 103, and fastening components 104. Strut mounting bracket 101 includes securing portion 105 and extending portion 106. Securing portion 105 includes openings 107 for receiving fastening components 104 (such as screws or other fasteners). Extending portion 106 includes base portion 108, first raised side portion 109, second raised side portion 110, protrusions 111, openings 112, tapered end 113 (see, e.g., FIG. 6), and channels 114. In examples, securing portion 105 and extending portion 106 may form a single integral part. For example, the securing portion 105 and extending portion 106 may be formed in a casting or molding process, although other manufacturing processes are possible and contemplated. In other examples, the securing portion 105 and extending portion 106 may be separately formed and attached to one another via any suitable process, such as welding, soldering, adhesive, mechanical coupling, etc. Base portion 108, first raised side portion 109, and second raised side portion 110 may also be formed a single integral part through molding, casting, forging, or any suitable process and/or may be attached through any suitable process.

Strut mounting bracket 101 (e.g., securing portion 105) is configured to be coupled to surface 102 (e.g., via fastening components 104 through openings 107). In examples, surface 102 may be a surface of a member of a wall frame (e.g., a stud). Fastening components 104 may include screws, nails, or the like. Any number of fastening components 104 may be used to couple strut mounting bracket 101 (e.g., securing portion 105) to surface 102.

Strut mounting bracket 101 (e.g., extending portion 106) is configured to slidingly receive strut 103. Strut 103 is an elongated member. In the example shown, strut 103 comprises a base section including one or more openings formed therein, and two side sections, each of which is substantially perpendicular to the base section and includes a 180-degree, inward curving hook at the end distal from the base section. Strut 103 may be made of any material or combination of materials, such as metals (e.g., steel). Strut 103 may be shaped and sized to receive clamps, brackets, and other attachment mechanisms that are designed to be received by, and secured to, the strut, and which allow other components (e.g., pipes, electrical boxes, valves, control boxes, etc.) to be secured to the strut. While FIGS. 1-6 illustrate strut 103 with a particular cross-sectional profile, it should be noted that strut 103 may have a different cross-sectional profile or other features than those shown.

Securing portion 105 may comprise a substantially flat plate. A front view of securing portion 105 may be a substantially trapezoidal shape with rounded corners, as illustrated in FIG. 9, or may be of any other shape (e.g., a substantially square shape, a substantially rectangular shape, a substantially circular shape, a substantially oval shape, a polygon, or the like). Although FIGS. 1-3 and 7-9 illustrate securing portion 105 with six openings 107, it should be noted that securing portion 105 may include any number of opening(s) 107 or be secured to the surface 102 (e.g., stud, beam, etc.) via other means. Securing portion 105 may be made of any material or combination of materials, such as metals or polymers (such as plastic or rubber). Securing portion 105 is coupled to (e.g., connected to, integral with, etc.) extending portion 106.

In examples, extending portion 106 extends substantially perpendicularly from securing portion 105 in a direction of a longitudinal axis defined as substantially perpendicular to front securing surface 119. A cross-sectional profile of extending portion 106 may be substantially U-shaped, as illustrated in FIG. 9, and generally be shaped and sized to mate with a particular size and shape of strut 103. Other shapes of strut 103 (and corresponding shapes of strut mounting bracket 101) are possible and contemplated. Extending portion 106 may be made of any material or combination of materials, such as metals or polymers (such as plastic or rubber). For example, the extending portion 106 may be mostly formed from metal for structural rigidity, while the protrusions may be formed from one or more polymers to permit a certain level of deformation, among other possibilities.

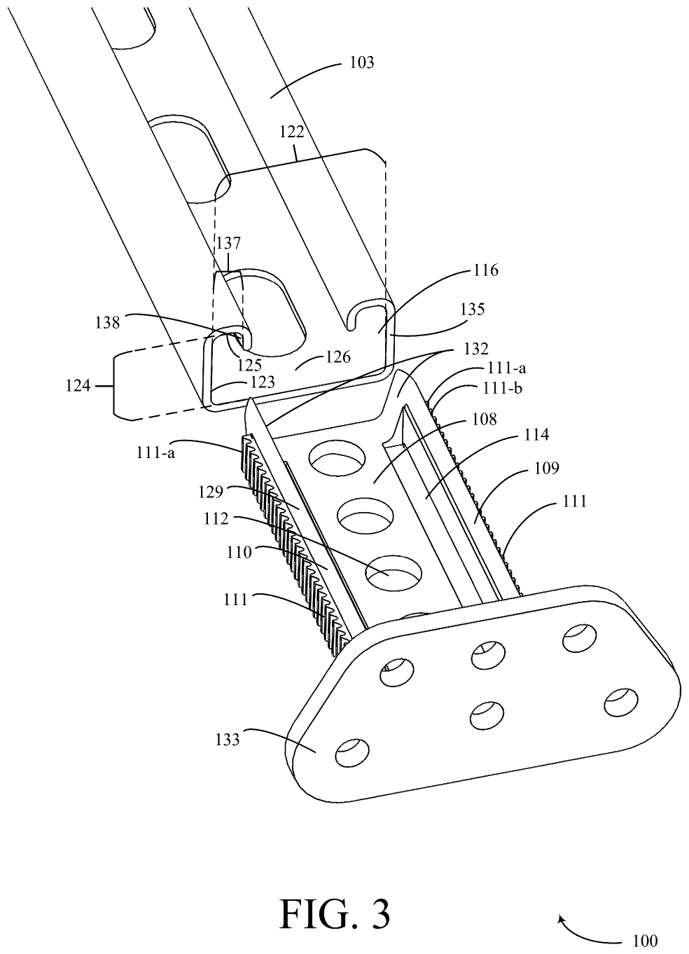

Implementation of strut mounting brackets 101 on either side of a strut 103 provides an adjustable range between a minimum and maximum length that is able to be supported by the strut and strut mounting brackets 101 between connection surfaces 102 (e.g., walls, studs, beams). In examples, the minimum length between connection surfaces 102 may be twice the total length of strut mounting bracket 101, that is, from rear surface 133 (see, e.g., FIG. 3) to a distal end of tapered end 113, where the minimum length is measured with a vector that is perpendicular to rear surface 133. The maximum length between supported surfaces may be a length of a supported strut plus twice the length of a distance from rear surface 133 to a furthest protrusion 111 from rear surface 133, for example, protrusion 111-a (see, e.g., FIG. 3), where the maximum length is measured with a vector that is perpendicular to rear surface 133.

Extending portion 106 includes base portion 108. Base portion 108 may include a substantially flat portion designed to slide along the substantially flat portion of the strut 103. Base portion 108 is coupled to (e.g., integral with) securing portion 105. Base portion 108 may extend substantially perpendicularly from securing portion 105.

Extending portion 106 also includes first raised side portion 109 and second raised side portion 110. First raised side portion 109 and second raised side portion 110 extend from securing portion 105. First raised side portion 109 and second raised side portion 110 may extend substantially perpendicularly from securing portion 105. Although FIGS. 1-3 and 7-9 illustrate first raised side portion 109 and second raised side portion 110 at substantially obtuse interior angles 136 (see, e.g., FIG. 9) relative to base portion 108, it should be noted that first raised side portion 109 and second raised side portion 110 may be at substantially right angles relative to base portion 108, or substantially acute angles relative to base portion 108. As described previously, base portion 108, first raised side portion 109, and second raised side portion 110 may form a single integral part. Intersections of base portion 108, first raised side portion 109, and second raised side portion 110 may be curved or sharp. Base portion 108, first raised side portion 109, and second raised side portion 110 may form a substantially U-shaped cross-sectional profile, as illustrated in FIG. 9. In examples where the extending portion 106 has a substantially U-shaped cross-sectional profile, the extending portion 106 may be open at the top (opposite the base portion 108). As will be understood by those of skill in the art, any reference to “top,” “bottom,” “front,” “rear,” “side,” etc. are used to describe the strut 103 and bracket 101 or other components of the strut mounting assembly 100 when in the orientation shown, for example, in the figures; however, the components described herein can be utilized in a variety of orientations, depending on the surface(s) to which the strut mounting assembly 100 is installed.

Extending portion 106 may include one or more protrusions 111. For example, base portion 108, first raised side portion 109, second raised side portion 110, or a combination of these, may include one or more protrusions 111. Protrusions 111 may include bumps, ridges, or the like, or a combination of these. Protrusions 111 may be made of substantially any material (e.g., plastic, metal, rubber) or combination of materials. In some examples, protrusions 111 may be made of a different material than that of at least a portion of extending portion 106, securing portion 105, or both. Protrusions 111 may be located at one or more surfaces and/or locations of extending portion 106. For example, protrusions 111 may be located on any surface of extending portion 106 that is configured to be substantially adjacent to inside surfaces of any kind of strut 103 when extending portion 106 slidingly receives strut 103. For example, protrusions 111 may be located on top surfaces 129 (see, e.g., FIGS. 3, 4), side surfaces 130, bottom surface 131, inside surface 132, or a combination of these (see, e.g., FIG. 9). While FIGS. 1-11 illustrate protrusions 111 located on side surfaces 130 (see, e.g., FIG. 6), it should be noted that protrusions 111 may be located on any of top surfaces 129, side surfaces 130, bottom surface 131, inside surface 132, or a combination of these. Additionally, while FIGS. 1-11 illustrate protrusions 111 protruding generally linearly (e.g., with a shark tooth profile) and substantially away from side surface 130, it should be noted that protrusions 111 may be bumps or any other type of protrusion extending in various ways from side surface 130 (or another surface of extending portion 106). Additionally, while FIGS. 1-3, 7, and 9 illustrate top surfaces 129 being angled or curved, it should be noted that top surfaces 129 may be flat (e.g., parallel to top base surface 115 (see, e.g., FIG. 4)). Likewise, although FIGS. 1-3 and 7-9 illustrate side surfaces 130 at substantially obtuse angles relative to base portion 108 (e.g., relative to top base surface 115), it should be noted that side surfaces 130 may be at substantially right angles relative to base portion 108 (e.g., relative to top base surface 115), or substantially acute angles relative to base portion 108 (e.g., relative to top base surface 115). Bottom surface 131 may be substantially parallel to top base surface 115.

In some examples, protrusions 111 may deform, deflect (e.g., inwards towards a side surface 130 or other surface from which they protrude), depress, or a combination of these, when extending portion 106 slidingly receives strut 103. One or more protrusions 111 may frictionally contact inside surfaces of strut 103 by resisting this deformation, deflection, or depression when extending portion 106 slidingly receives strut 103. For example, protrusion 111-a may deform, deflect, or depress, and thus frictionally contact inside strut surface 116 when extending portion 106 slidingly receives strut 103. This frictional contact when one or more protrusions 111 are frictionally contacting strut 103 enables extending portion 106 to resist longitudinal movement of strut 103. In addition, as discussed further below, longitudinal movement of the strut 103 towards securing portion 105 may be further resisted by an end of the strut 103 contacting an edge of a given protrusion 111 that is outside of strut 103.

In some examples, a first distance (e.g., a horizontal or vertical component of a distance) from a distal end of at least one protrusion of protrusions 111 to an opposite end of extending portion 106 relative to the at least one protrusion may be greater than a second distance from a first corresponding inside surface of strut 103 to an opposite inside surface of strut 103 relative to the first inside surface of the strut 103. For example, distance 120 (see, e.g., FIG. 5) from distal end 121-a of protrusion 111-c to distal end 121-b of protrusion 111-d may be greater than distance 122 (see, e.g., FIG. 3) from inside surface 116 of strut 103 to inside surface 123 of strut 103. In another example, when at least one protrusion 111 is located on top surface(s) 129, a distance from a distal end of the at least one protrusion on top surface 129 to bottom surface 131 or another distal end of another protrusion 111 on bottom surface 131, or from top surface 129 to a distal end of a protrusion 111 on bottom surface 131, may be greater than distance 124 (see, e.g., FIG. 3) from surface 125 of strut 103 to surface 126 of strut 103 (see FIGS. 3, 8). For example, such distance might be measured as a shortest distance from the distal end of the at least one protrusion on top surface 129 to bottom surface 131 or the other distal end of the other protrusion 111 on bottom surface 131. Or it may be measured using a vector that is substantially perpendicular to bottom surface 131 from the distal end of the at least one protrusion on top surface 129 to a plane created by bottom surface 131 or a plane substantially parallel to bottom surface 131 that intersects the other distal end of the other protrusion 111 on bottom surface 131, among other possibilities.

Other protrusion 111 placements are possible and contemplated, such as on an upper portion of inside surface 132 (see FIG. 7) (e.g., a portion of inside surface 132 that is proximal to top surface 129). Such protrusions 111 could be sized and positioned to engage the inside surface of the returning “hook” portion of the strut 103, among other possibilities. For example, a distance from a distal end of at least one protrusion on the upper portion of inside surface 132 may be greater than distance 137 (FIG. 3) from surface 123 to surface 138 (FIG. 3). Any placement of protrusion 111 that requires deflection of the protrusions 111 when the extending portion 106 slidingly receives strut 103 is possible and contemplated. Such distances described herein may be measured using a shortest distance between the two points or between any point on a referenced surface and another referenced point, or between whichever two points on each referenced surface give a shortest distance. Alternatively, the shortest distance may be measured using a vector that is substantially perpendicular to at least one of the referenced surfaces. Alternatively, for the comparison of distances between surfaces and any distance involving a protrusion (e.g., comparing the distance 122 and distance 120), the distance between two surfaces may be measured as the distance between points on the surfaces that are just below, adjacent, or closest to the corresponding protrusion 111 that is being considered in the comparison. For example, if distance 120 measures the distance between protrusion 111-c and protrusion 111-d (FIG. 5), it would be understood that the comparison distance between opposite surfaces 130 (FIG. 6) would be between the points on opposite surfaces 130 that are closest to protrusions 111-c and 111-d, respectively, which are just below, right next to, or adjacent to those protrusions 111 (e.g., using vectors that are substantially perpendicular to the surfaces at the location of the protrusions, where the vectors also intersect the distal ends of the protrusions).

In some examples, protrusions 111 may be located on inside surfaces of strut 103 (e.g., inside surface 123, surface 126, inside strut surface 116, surface 125, surface 138, or a combination of these (see, e.g., FIG. 3)). In some examples, there may be some or no protrusions 111 on surfaces of extending portion 106, and there may be one or more protrusions 111 on the recited surfaces of strut 103. Such protrusions 111 may be oriented similarly or have similar characteristics as protrusions 111 described herein on extending portion 106. In some examples, when protrusions 111 are on strut 103, such protrusions 111 may be “flipped” (e.g., distal ends of protrusions 111 may frictionally contact surfaces of extending portion 105 when extending portion 105 slidingly receives strut 103).

It should be noted that one or more aspects of strut mounting bracket assembly 100 may be symmetrical or substantially symmetrical, and thus, surfaces identified in the Figures may be similarly identified on substantially opposite or corresponding sides of strut mounting bracket assembly 100. A lack of an identifier in the Figures for opposite or corresponding surfaces does not exclude the substantially opposite or corresponding surface from being identifiable by the same identifier used for an opposite or corresponding surface.

Protrusions 111 may have particular geometries. For example, as illustrated in FIGS. 4, 5, and 10, when protrusions 111 are ridges having a generally shark-tooth profile, protrusions 111 may have first protrusion sides 117 and second protrusion sides 118. First protrusion sides 117 may include a linear portion that is substantially perpendicular to a sliding direction when extending portion 106 slidingly receives strut 103 and may be positioned opposite from the securing portion 105. Depending on the surface of the extending portion 106 from which the protrusions 111 extend, a linear portion of the first protrusion sides 117 may be substantially perpendicular to top base surface 115, substantially perpendicular to side surfaces 130 and/or substantially parallel to front securing surface 119, among other possibilities. Second protrusion sides 118 may be positioned towards the securing portion 105 and angled relative to the linear portion of first protrusion sides 117, for example, at a substantially 45 degree angle relative to the linear portion of first protrusion sides 117. In examples, the first protrusion side and second protrusion side may be joined by a rounded or flat top portion between them. In some other examples, protrusions 111 may be bumps or semi-circle shapes, or any other shape. In some examples, the shark-tooth profile of protrusions 111 may be flipped, where first protrusion sides 117 are proximal to front securing surface 119, and second protrusion sides 118 are distal to front securing surface 119.

First protrusion side 117 of protrusion 111 (see FIGS. 3, 4) may be configured to prevent or resist further longitudinal movement of strut 103 in the direction toward securing portion 105. For example, protrusion side 117 of protrusion 111-a may contact surface 116 of strut 103 when the strut 103 is slidingly received by strut mounting bracket 101. Prior to the strut 103 being slidingly received by strut mounting bracket 101, protrusion 111-a may be relatively undeformed, undeflected, and/or undepressed relative to other protrusions 111 toward a distal end of extending portion 106. When the end of strut 103 is slid onto strut mounting bracket 101 past protrusion 111-a, the protrusions 111-a (on both sides of strut mounting bracket 101) may frictionally engage with inside surfaces of strut 103. When extending portion 106 receives strut 103, deformed, deflected, and/or depressed protrusions 111 may deflect towards a side surface 130 (e.g., inwards) and/or towards front securing surface 119 (e.g., back). The angles of second protrusion sides 118 may provide space for such backward deflection towards front securing surface 119.

In some examples, the resistance imparted on strut 103 by protrusions 111 may be greater in one linear direction than the other due to the geometry of protrusions 111. For example, in the example illustrated in the Figures, the friction imparted on strut 103 by protrusions 111 is greater when sliding strut 103 along extending portion 106 towards securing portion 105. Turning to FIG. 4, when protrusions 111 are deformed during the sliding, second protrusion side 118 (e.g., the angled side) may buttress against deflection of the protrusion towards securing portion 105 more than first protrusion side 117 (e.g., the straighter wall of the protrusion), causing increased friction imparted on strut 103 when strut 103 is slidingly moved towards securing portion 105. Additionally, undeflected or undeformed protrusions 111 (e.g., protrusion 111-b when strut 103 is in the position shown in FIG. 4) outside of strut 103 may catch (e.g., exert a normal force on) the edge of strut 103 (e.g., catch surface 135 (FIG. 3)) until protrusion 111-b is pinched (e.g., by an installer or user) or forced to deflect or deform enough to accommodate strut 103 sliding over extending portion 106. Extending portion 106 may include one or more openings 112. Openings 112 may be holes through base portion 108. While FIGS. 1-5, 7, 8, and 10 illustrate five openings 112, it should be noted that one or more openings 112, or no openings 112 may be included in base portion 108.

Extending portion 106 may include tapered end 113. Tapered end 113 may be located at a distal end of extending portion 106 furthest from securing portion 105. Tapered end 113 may include a tapering cross-sectional profile of extending portion 106. Tapered end 113 may allow extending portion 106 to more easily slidingly receive strut 103.

In some examples, extending portion 106 may include channels 114. Channels 114 may be the result of manufacturing processes or molding. Channels 114 may facilitate the deformation, deflection, and/or depression of protrusions 111. Channels 114 may include first channel surface 127 and second channel surface 128 (see, e.g., FIG. 7). First channel surface 127 and second channel surface 128 may be flat. First channel surface 127 may be substantially perpendicular to second channel surface 128. First channel surface 127 may be substantially parallel to top base surface 115. First channel surface 127 may be formed lower than top base surface 115.

In addition, presently disclosed strut mounting brackets 101 may ease installation of strut 103. For example, during installation, an installer may slide strut 103 over two strut mounting brackets 101 (a strut mounting bracket 101 on each side of strut 103) to form strut mounting bracket assembly 100. In order to slide the strut 103 over the strut mounting brackets 101, the installer may apply significant force to the brackets 101 and/or pinch in protrusions 111 to allow the ends of strut 103 to slide past the protrusions 111. The installer may then place strut mounting bracket assembly 100 between two opposing surfaces (e.g., surface 102 and another surface 102 for the other strut mounting bracket 101) to which the installer may affix strut mounting bracket assembly 100. The installer may slide one or both strut mounting brackets 101 outward towards the respective surface(s) (e.g., surfaces 102), until rear surfaces 133 of strut mounting brackets 101 contact the respective surfaces 102.

Protrusions 111 may lock strut 103 in place as discussed. For example, the installer may pinch or otherwise deform protrusions 111 (e.g., which may be flexible protrusions) to slide strut 103 relative to the strut mounting bracket(s) 101. When the strut mounting bracket assembly 100 is at the desired length, protrusions 111 lock the position of strut 103 with respect to strut mounting brackets 101 by exerting one or more forces on strut 103. The one or more forces may include a frictional force exerted by one or more protrusions 111 on inside strut surface 116, surface 125, surface 123, surface 126, and/or any other surface inside strut 103. Additionally or alternatively, the one or more forces may include a normal force exerted by one or more protrusions (e.g., by first protrusion side 117 of protrusion 111-b) on a parallel surface on strut 103 (e.g., surface 135), resisting or preventing movement of strut 103 towards securing portion 105. The installer may bolt, screw, nail, or otherwise secure securing portion 105 to surface 102, and the other securing portion 105 to the other surface for the other strut mounting bracket 101 on the opposite end of the strut. Strut mounting bracket 101 provides an improved and easier installation process by being able to vary the length of the strut mounting bracket assembly 100, while maintaining a rigid assembly via the friction and resistance imparted on the strut by protrusions 111, and quickly install the adjustable-length assembly 100 in between opposing surfaces 102.

In some other examples, strut mounting bracket assembly 100 may come pre-assembled (e.g., as one assembly of a first strut mounting bracket 101, strut 103, and a second strut mounting bracket 101) such that an installer may selectively extend or contract the strut mounting brackets 101 (e.g., without having to slide strut 103 over the first and second strut mounting brackets 101 and/or pinch or otherwise deform one or more protrusions 111 for the strut mounting brackets 101 to slidingly receive strut 103). For example, the first strut mounting bracket 101 may be pre-assembled with one end of strut 103, and the second strut mounting bracket 101 may be pre-assembled with an opposite end of strut 103.

Strut mounting brackets 101 also allow for installation of struts 103 anywhere on surface 102, for example, at a back end of a stud (e.g., where the strut is adjacent or substantially adjacent to a back wall), so that enough room may be provided in the direction towards a front end of the stud to allow for large components to be mounted to strut 103 and still be contained within the overall stud/wall depth. In examples, this may be advantageous over a design that would require access to both the front and back of a strut to secure the strut to a securing mechanism or to secure separate telescoping pieces of a strut to each other in order to fix a desired length. For example, such designs may require a minimum distance that the strut may be placed away from a back wall or other surface so that a screw/nut or other fastening mechanism can be secured via the back side of the strut. In contrast, presently disclosed strut mounting brackets 101 may not require access to multiple sides of strut 103 during installation or maintenance. In examples, the presently disclosed design may permit strut mounting brackets 101 to be placed anywhere on surface 102 (such as a wall stud), allowing strut 103 to be placed adjacent or substantially adjacent to another surface, such as a back wall, thereby maximizing the depth of components that can still be attached to a strut 103 while being concealed within a finished wall.

Although the present disclosure discusses the implementation of these techniques in the context of mounting a strut in a wall using one or more strut mounting brackets, the technology introduced above may be implemented for a variety of mounting needs. A person of skill in the art will understand that the technology described in the context of securing a strut in a wall could be adapted for use in any other contexts that involve securing a member at its distal ends. Additionally, a person of ordinary skill in the art will understand that the strut mounting bracket assembly may be implemented or installed with a variety of setups.

Those skilled in the art will recognize that the methods and systems of the present disclosure may be implemented in many manners and as such are not to be limited by the foregoing aspects and examples. In this regard, any number of the features of the different aspects described herein may be combined into single or multiple aspects, and alternate aspects having fewer than or more than all of the features herein described are possible. Functionality may also be, in whole or in part, distributed among multiple components, in manners now known or to become known.

Moreover, the scope of the present disclosure covers conventionally known manners for carrying out the described features and functions, and those variations and modifications that may be made to the components described herein as would be understood by those skilled in the art now and hereafter. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

Further, as used herein and in the claims, the phrase “at least one of element A, element B, or element C” is intended to convey any of: element A, element B, element C, elements A and B, elements A and C, elements B and C, and elements A, B, and C. In addition, one having skill in the art will understand the degree to which terms such as “about” or “substantially” convey in light of the measurements techniques utilized herein. To the extent such terms may not be clearly defined or understood by one having skill in the art, the term “about” shall mean plus or minus ten percent, and when used with respect to angular measurements, the term “substantially” shall mean within plus or minus ten degrees (e.g., “substantially perpendicular” shall mean within ten degrees from exactly perpendicular, and “substantially parallel” shall mean within ten degrees from exactly parallel).

Numerous other changes may be made which will readily suggest themselves to those skilled in the art and which are encompassed in the spirit of the disclosure and as defined in the appended claims. While various aspects have been described for purposes of this disclosure, various changes and modifications may be made which are well within the scope of the disclosure. Numerous other changes may be made which will readily suggest themselves to those skilled in the art and which are encompassed in the spirit of the disclosure and as defined in the claims.

What is claimed is:

1. A strut mounting bracket, comprising:
a securing portion configured to couple to a surface; and
an extending portion coupled to the securing portion, wherein the extending portion has a substantially U-shaped cross section, wherein the extending portion is configured to slidingly receive a strut, wherein at least one surface of the extending portion comprises a plurality of protrusions, and wherein the plurality of protrusions are configured to frictionally contact an inside surface of the strut.

2. The strut mounting bracket of claim 1, wherein the plurality of protrusions are configured to deflect inwards when the extending portion slidingly receives the strut and resist longitudinal movement of the strut.

3. The strut mounting bracket of claim 1, wherein the extending portion includes a tapered end.

4. The strut mounting bracket of claim 1, wherein a longitudinal axis of the extending portion is substantially perpendicular to a planar surface of the securing portion.

5. The strut mounting bracket of claim 1, wherein at least one of the plurality of protrusions is configured to exert a normal force on an end of the strut.

6. The strut mounting bracket of claim 1, wherein the extending portion comprises a base portion, a first raised side portion, and a second raised side portion, wherein the base portion is coupled to the first raised side portion and the second raised side portion.

7. The strut mounting bracket of claim 6, wherein the first raised side portion and the second raised side portion are at substantially obtuse angles relative to the base portion.

8. The strut mounting bracket of claim 6, wherein the base portion comprises a plurality of openings that are substantially circular.

9. The strut mounting bracket of claim 1, wherein the base portion is wider than first raised side portion or the second raised side portion.

10. The strut mounting bracket of claim 1, wherein the indented track comprises a first flat surface and a second flat surface, and wherein the first flat surface is substantially perpendicular to the second flat surface.

11. The strut mounting bracket of claim 1, wherein the plurality of protrusions comprise a plurality of ridges.

12. The strut mounting bracket of claim 11, wherein each protrusion of the plurality of protrusions has a first side and a second side that is angled relative to the first side.

13. The strut mounting bracket of claim 1, wherein the securing portion comprises a plurality of openings.

14. The strut mounting bracket of claim 1, wherein the plurality of protrusions cause the strut to resist movement in a first linear direction toward the securing portion more than in a second, opposite linear direction away from the securing portion.

15. The strut mounting bracket of claim 1, wherein the securing portion and the extending portion comprise a single integral part.

16. A strut mounting bracket, comprising:
a securing portion configured to couple to a surface; and
an extending portion coupled to the securing portion, wherein the extending portion is configured to slidingly receive a strut, and wherein the extending portion comprises:
a base portion;
a first raised side portion coupled to the base portion; and
a second raised side portion coupled to the base portion,
wherein the first raised side portion comprises a first plurality of protrusions configured to contact a first inside surface of the strut, wherein the second raised side portion comprises a second plurality of protrusions configured to contact a second inside surface of the strut, and wherein a first distance between a first protrusion of the first plurality of protrusions and a second protrusion of the second plurality of protrusions is greater than a second distance between the first inside surface and the second inside surface.

17. The strut mounting bracket of claim 16, wherein the first plurality of protrusions and the second plurality of protrusions are configured to deflect inwards when the extending portion slidingly receives the strut.

18. The strut mounting bracket of claim 16, wherein the extending portion is substantially U-shaped.

19. The strut mounting bracket of claim 16, wherein the extending portion is substantially perpendicular to the securing portion.

20. A strut mounting bracket assembly, comprising:
a strut;
a first strut mounting bracket, comprising:
a first securing portion configured to couple to a first surface, and
a first extending portion coupled to the first securing portion,
wherein the first extending portion is configured to slidingly receive a first end of the strut, wherein the first extending portion comprises a first plurality of protrusions configured to contact a first inside surface of the strut and resist movement of the strut in a first longitudinal direction more than movement in a second, opposite longitudinal direction; and
a second strut mounting bracket, comprising:
a second securing portion configured to couple to a second surface, and
a second extending portion coupled to the second securing portion,
wherein the second extending portion is configured to slidingly receive a second end of the strut, wherein the second extending portion comprises a second plurality of protrusions configured to contact a second inside surface of the strut and resist movement of the strut in the second longitudinal direction more than movement in the first longitudinal direction.
